(19) United States
(12) Patent Application Publication
(10) Pub. No.: US 2011/0074073 A1
(43) Pub. Date: Mar. 31, 2011

(54) METHOD OF PRODUCING CAST IRON

(76) Inventors: Ronald Jay Beyerstedt, Winona, MN (US); Ricklin L. Heintz, Winona, MN (US)

(21) Appl. No.: 12/892,706

(22) Filed: Sep. 28, 2010

Related U.S. Application Data
(62) Division of application No. 10/640,471, filed on Aug. 12, 2003, now abandoned.
(60) Provisional application No. 60/402,831, filed on Aug. 12, 2002.

(51) Int. Cl. C21B 7/00; F27B 1/16; C21B 7/16

(52) U.S. Cl. 266/216

(57) ABSTRACT

A method of producing a silicon-and-carbon-enriched cast iron melt. The method can include melting an initial cupola charge in a cupola, conducting the molten metal to a mixing vessel, increasing the silicon and carbon content of the molten metal by a substantially continuous addition of granular silicon carbide having a purity of greater than 94% and a size of less than ⅜″ to the mixing vessel while simultaneously agitating the molten metal to an extent sufficient to bring the silicon carbide into solution with the molten metal, and conducting the silicon-and-carbon-enriched molten metal away from the mixing vessel.

### CROSS-REFERENCES TO RELATED APPLICATIONS

This application is a Divisional of U.S. application Ser. No. 10/640,471, filed Aug. 12, 2003, which claims the benefit under 35 USC 119(e) of U.S. Provisional Application Ser. No. 60/402,831, filed Aug. 12, 2002, which applications are incorporated herein by reference in their entirety.

### FIELD OF THE INVENTION

This invention relates to the field of the production of cast iron, and more specifically to a system and method of adding silicon to a cast iron melt.

### BACKGROUND

Silicon is an alloying element in the production of cast iron. Silicon not only promotes graphitization of carbon, but also increases the hardness and strength of the ferrite phase. Common commercially used gray irons include approximately 2.25 weight percent silicon. Depending upon the required properties, however, the silicon content may vary from 1.50 to 3.00 weight percent. The silicon contained in the metallics and in auxiliary additives in the cupola charge typically provide the silicon necessary to meet the specifications of the melt. This adds to the material cost of the initial charge since steel scrap is less expensive than the average cost of pig iron, foundry returns, and purchased cast iron scrap.

Final adjusting of the silicon content of the melt has been attempted by additions to the transfer or pouring ladle. Heretofore, such procedures have been effective in producing only minor changes in the silicon content of the melt, measured on the order of tenths of a percent. Silicon has also been added as an inoculant to the transfer or pouring ladle, but this also produces very little change in the overall silicon content of the melt. Thus, the accepted practice is to use a high percentage of the more expensive silicon rich metallics in the initial charge, to add auxiliary silicon bearing additives and to make special provisions to protect the silicon content during melting.

U.S. Pat. No. 4,072,511 issued in 1978 and is incorporated herein by reference in its entirety. The '511 patent discusses a method of producing cast iron including providing a mixing vessel between a cupola and a holding tank. The patent discusses adding granular silicon carbide to the mixing vessel while agitating the melt. However, in practice the process of the '511 patent used a silicon carbide material which required a long mixing time and a large mixing chamber. These factors resulted in an unacceptable temperature loss of the melt and an impractically sized mixing vessel.

Accordingly, there is a long-felt need in the art for a better silicon-adding technique to provide for a shorter mixing time and that can be used in production more easily.

### SUMMARY

A variety of techniques are discussed to improve a cast iron process so as to allow for less temperature loss, smaller mixing vessels, and better efficiency. One method includes melting an initial cupola charge in a cupola, and increasing the silicon and carbon content of the molten metal by a substantially continuous addition of granular silicon carbide having a purity of greater than 94% and a size of less than ⅜″ to the molten metal.

### BRIEF DESCRIPTION OF THE DRAWINGS

FIG. 1 shows a schematic representation of a cast iron melt system according to one embodiment.

FIG. 2 shows a schematic representation of a cast iron melt system according to one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

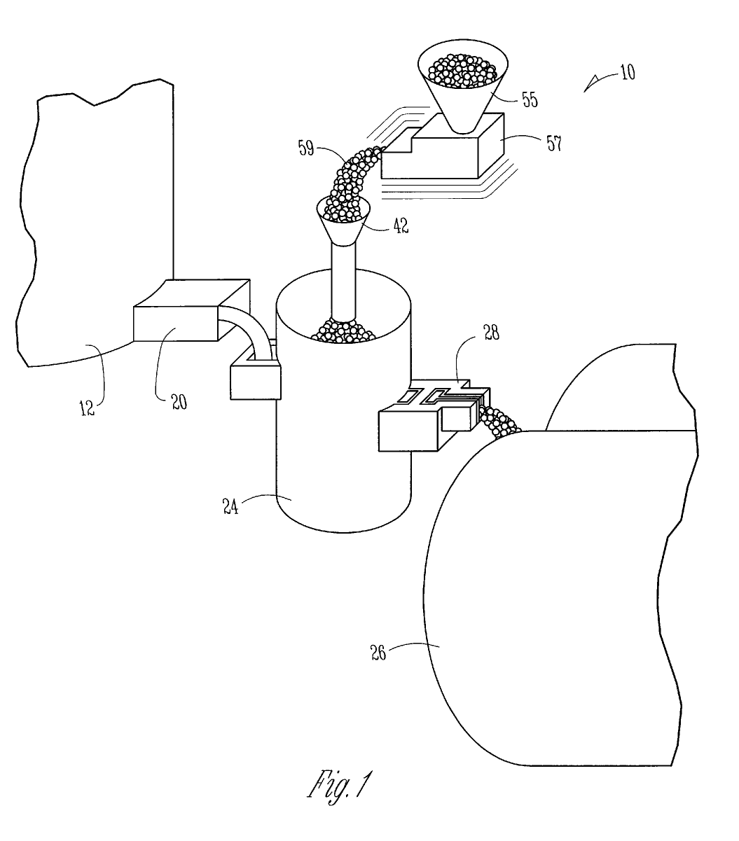

FIG. 1 shows a schematic representation of a system 10 for producing cast iron according to one embodiment. The duplexed melting system 10 includes a cupola 12 which feeds molten metal down a spout 20. The spout 20 conducts the molten metal to a mixing vessel, generally indicated at 24. As will be more thoroughly described herein, the mixing vessel 24 is employed to increase the silicon and carbon content of the melt by an addition of silicon-and-carbon-containing additives, preferably granular silicon carbide. The molten metal is then conducted into a holding vessel, such as an electric furnace 26, where it is held before being transferred, as needed, to ladles for transport to the pouring floor.

Mixing vessel 24 is constructed of standard refractory materials and includes a spout 28. One embodiment includes a teapot-type spout as discussed in patent '511. The metal is agitated sufficiently to insure substantially homogeneous mixing and disassociation of the silicon carbide in the metal.

The silicon and carbon content of the metal is increased by adding granular silicon carbide 59 to the mixing vessel 24. Silicon carbide is used because it contains both silicon and carbon while other additives contain only one or the other. By increasing the silicon and carbon content of the metal at the mixing vessel in the manner described, much closer control of the chemistry of the metal can be maintained. For example, it is standard foundry practice to monitor the carbon equivalent of the metal at the spout of the holding vessel 26. According to customary practice, fluctuations in the carbon equivalent have been corrected by adjusting the alloy content of the charge going into the cupola. Emergency corrections to the chemistry of the metal are also made at the spout of the holding vessel by additions of hardening or softening inoculants. This procedure presents a twofold problem. First of all, there is a time lag of at least an hour from the top of the cupola to the spout. Hence, there is a significant delay between the time corrections to the chemistry of the charge going into the cupola are made and the time at which such corrections actually begin to take effect. In other words, the extra silicon and carbon added to the cupola are at least an hour away from the holding vessel. The second problem is related to the first in that, during the interim, ladle additions must be made to the melt to produce castings which meet specification. Ladle additions are, of course, expensive and increase the material cost of the metal. Moreover, there is a limit as to the amount of material which can be added. As a general rule, only 2-6 pounds of inoculant per ton of metal can be added to the holding vessel. Standard inoculants contain a maximum of about 75% silicon. Hence, only about a 0.20% increase in the silicon content can be achieved in this manner.

By increasing the silicon and carbon content of the metal in the mixing vessel, almost immediate adjustment of the carbon equivalent can be achieved. This is so regardless of the natural fluctuations in the carbon equivalent which occur during the melting process. Additionally, more accurate adjustments can be made. The tendency to overcompensate is reduced because the effects of the silicon addition can be measured almost immediately. Thus a great amount of guesswork can be eliminated. (However, if an imbalance does occur in the cupola melt, precise control of the final chemistry may require trim addition of silicon or carbon).

The granular silicon carbide is introduced into the mixing vessel 24 through a pipe 42. The pipe 42 is fed from a suitable storage container 55 by means of an electrically operated vibratory feeder 57. Vibratory feeder 57 can include rheostat controls for adjusting the rate of flow of the material being fed into the pipe 42. Hence, the rate at which silicon carbide is being added to the metal can be adjusted to correct fluctuations in the carbon equivalent being measured at the spout of the holding vessel 26. Generally, the silicon content is added to the melt on a continuous basis at a rate which may fluctuate depending on the silicon content and/or carbon equivalent of the melt. As suggested above, only slight fluctuations in the silicon and carbon content should occur since a more consistent carbon and silicon curve will result from the lower silicon input.

The sizing and purity of the silicon carbide granules 59 of the present system provides faster disassociation. In the past, the system discussed in the '511 patent utilized silicon carbide having a purity of 94% and a size of ⅜″ by down. However, it has been discovered that the size and purity of the granules controls the time needed for the particle to fully disassociate when added to molten metal. The time the molten metal needs to be mixed is directly related to the temperature loss that occurs. For example, the old material had a retention time of approximately 6 minutes. Thus a 100 ton/hr system needed a 10 ton mixing vessel to provide an acceptable melt. The present system uses a higher purity, smaller size silicon carbide. In one example, the silicon carbide can have a retention time of 1.5 minutes in a system and be added to provide 1.5% by weight addition. This leads to the present system having a smaller, more practical mixing vessel, which in turn leads to a smaller temperature loss during the process.

The sizing of the silicon carbide granules can vary. One example uses a size of less than ⅜″ by mesh. One example uses a size of 10-100 mesh. One example uses 8 mesh×70 mesh. One example uses a 50 mesh by 140 mesh. One example uses a silicon carbide having the specifications of: 6 mesh: 0; 8 mesh: 5%; 20 mesh: 25-60%; 50 mesh 25-40%; and minus 100 mesh: 2% max. Other examples use sizes of about 6 mesh; about 8 mesh; about 20 mesh; about 50 mesh; and about 100 mesh. The size and amount of the biggest silicon carbide particles in a given mix controls the disassociation time which, in turn, determines the size of the mixing chamber.

Regarding purity of the silicon additive, in one example, the present system uses a silicon carbide having a purity of about 97%. Some embodiment use a purity of greater than about 94%; greater than or equal to about 95%; greater than or equal to about 96%; and greater than or equal to about 97%. The purity of the material affects the rate of disassociation of the silicon carbide into the molten metal. It has been discovered that higher purity disassociates faster.

The use of a finely sized, high purity silicon carbide allows a seventy percent reduction in size for the vessel compared to the process discussed in the '511 patent. This vessel size reduction is an important factor in regards to fitting the mixing chamber into a foundry's existing physical plant without major equipment and structure changes. Moreover, temperature losses using the silicon carbide discussed above is also greatly reduced. For example, the temperature loss with a 50 mesh×140 mesh, 97% purity silicon carbide in a twenty ton per hour cupola melting operation is 10 to 15 degrees F. Using the ⅜″ size, 94% silicon carbide material as in the past, a temperature drop of over 100 degrees F. would have been expected.

As discussed above, the molten metal is agitated in the mixing vessel 24. For example, one embodiment employs the technique of the '511 patent where adequate agitation in the mixing vessel 24 is provided by forcing an inert gas, such as nitrogen, through multiple porous plugs located in the bottom of the mixing vessel 24. Each of the porous plugs include a gas-permeable, ceramic body which is located in an opening in the bottom lining of the mixing vessel 24. Inert gas forced through the porous plug will enter the metal in the form of finely divided bubbles which agitate the metal as they rise to the surface.

However, metal temperature loss during the mixing operation can be reduced by other embodiments of the present system. For example, one embodiment eliminates the nitrogen gas mixing process of the '511 patent and uses a vibration agitation method. This vibration method can be accomplished using mechanical, acoustic or electrical techniques. One embodiment uses a stirring technique using low cycle electrical current designed to provide rapid agitation to the molten metal.

One advantage of the method disclosed herein is the large savings which can be made in the cost of materials and fuel. Due to the fact that the metallics and auxiliary additives need not be the primary source of silicon in the metal, greater flexibility can be achieved in making up the initial cupola charge. As mentioned above, it has been standard practice to include in the initial charge a large portion of metallics having relatively high silicon and carbon contents. Therefore, pig iron, foundry returns, and purchased cast iron scrap made up most of the charge. Since, by employing the method described herein, it is no longer necessary for the metallics to provide the major source of silicon, metallics having lower silicon contents may be used. In other words, greater amounts of steel scrap and cast iron borings may be used to make up the cupola charge.

In one example a low silicon metallic charge including 80% steel scrap produced a 0.80% silicon and 2.80% carbon content. A 1.75% silicon carbide addition successfully raised the silicon to 2.0% and the carbon to 3.3%. The mixing vessel was sized for a 1.5 minute retention time.

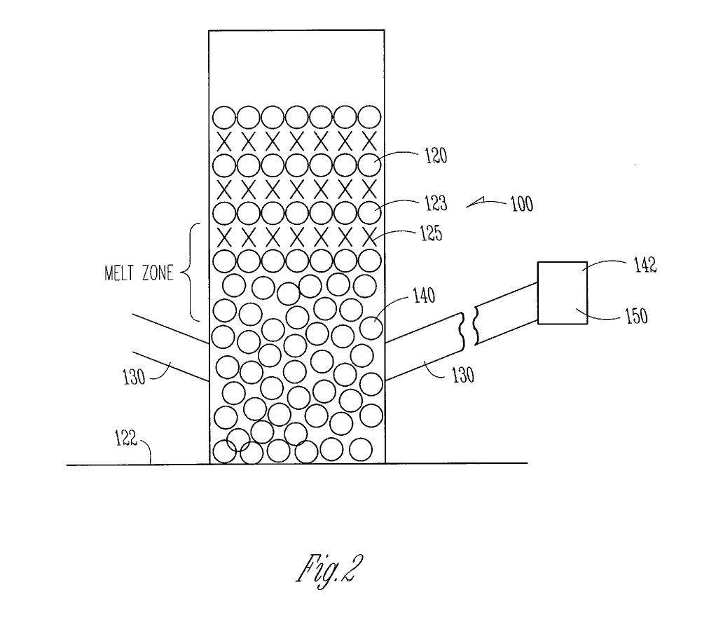

FIG. 2 shows a schematic representation of a system 100 for producing cast iron according to one embodiment. System 100 includes a cupola 120 filled with alternating layers of coke 123 and metallics 125. Cupola 120 feeds molten metal down a spout 122. Tuyeres 130 are located around the cupola to inject air into the cupola. In this example, silicon carbide 142 is delivered directly to the cupola proximate the lower part of the melt zone. In one embodiment, the silicon carbide is delivered through one or more of tuyeres 130 via a pneumatic system 150. The granular silicon carbide is delivered in a substantially continuous manner to the tuyere and the melt zone.

In this embodiment, the process is to inject silicon carbide 142 into the cupola tuyeres 130 and then let the cupola combustion air transport the material into the melt zone. The addition of the silicon carbide to the tuyeres 130 behaves similar to adding silicon carbide to the reaction vessel, as discussed above, and the above discussion regarding the types and purity of silicon carbide is incorporated herein by reference.

By adding the silicon carbide to the tuyere, it enables the material to contact the molten metal descending though the coke bed 140. If the silicon carbide was added higher up in the cupola, the possibility exists that the silicon carbide would become entrained in the combustion air stream and exit the cupola in the exhaust gases before coming in contact with the molten metal. The cupola tuyeres are used for the addition of silicon carbide due to the simplicity of the operation. However, some embodiments utilize other locations in the lower melt zone.

Since this embodiment does not require the reaction vessel to accomplish the chemistry addition, several benefits are gained. The addition of silicon carbide through the cupola tuyere can eliminate the external mixing vessel since the disassociation of the silicon carbide into the molten metal is completed before the molten metal exits the cupola furnace. The temperature loss that occurs in the reaction vessel is eliminated when the silicon carbide is added to the tuyere. Tuyere addition minimizes or eliminates any problems with cupola shutdowns. With the reaction vessel system discussed above, consideration must be given to the decrease in temperature that occurs in the reaction vessel's molten metal when the cupola is shutdown. This is not a significant problem for the reaction vessel but it is one more consideration for cupola operating personnel. Moreover, the physical installation needed to accomplish silicon carbide addition is simplified. Since the silicon carbide only needs to placed into the tuyere pipe, many types of addition equipment are useable. One method is to pneumatically batch transport the silicon carbide to the cupola tuyere from a remote location. Other material handling systems will also work but the pneumatic system appears simplest to implement. Also, the pneumatic transporter simplifies automation of the present process. The equipment needed and its remote location provides a less harsh operating environment, making the equipment less prone to mechanical failure.

In one embodiment, the present system uses the same sizing of silicon carbide for the addition to the tuyeres as what was used for the reaction vessel. However, it is projected that by adding to the tuyeres one may be able to use a coarser material, since in the cupola, dwell time can be infinite without causing problem. In one embodiment, the system utilizes the higher purity material, 97% purity, for example. However, it is projected that it may be possible that a less pure material can be used.

### Overview of Present Process

The chemistry requirement for cupola melted iron has always influenced charge material selection and cupola operation. Predetermined carbon and silicon levels needed to be present in the melted metal and this chemistry was attained from the materials included in the cupola charge. These chemistry constraints greatly reduced melting efficiency. Using the present process the melter is no longer concerned with primary chemistry control in the cupola. They are simply melting iron, so are freed from many of the constraints of conventional cupola practice.

The present process replaces a portion of, or all, of the auxiliary silicon in the cupola charge. Silicon carbide contains approximately 70% silicon and 30% carbon. The addition of silicon carbide to gain silicon will also provide carbon increases. This then permits a reduction in a portion of the high carbon metallic charge materials and/or a portion of the coke used. Carbon pickup rate is also enhanced with the present process due to fact that the low silicon content of the melted iron, once the auxiliary silicon has been removed, increases the absorption rate of carbon.

The present process can lead to reductions in charge material costs. Since carbon and silicon can be instantaneously adjusted after melting, the use of “rich” metallics such as pig iron, cast iron and other high carbon-silicon charge materials can be eliminated. Alternate lower cost materials can be used without the previously experienced offsetting cost for increased coke consumption or quality concerns. The cupola charge can be constructed based on the most economical metallic charge materials and this provides significant savings.

When high purity silicon carbide is added to molten metal, its disassociation into the molten metal is exothermic with very little, if any, carbon and silicon is lost to slag type reactions. The high degree of carbon and silicon recovery experienced with the present process leads to very predictable chemistries. The exothermic nature of the addition enhances molten metal temperature as opposed to the temperature losses associated with other alloy additions.

Today, silicon carbide is, in most instances, the most economical source for auxiliary silicon in the cupola charge. It is used in the cemented brick form. There are also straight ferrosilicon and combinations of ferrosilicon and carbon used, also in the cement brick form. All of these briquettes or bricks are directly charged into the cupola along with the metallic and coke charge materials and subsequently melted. In all cases the briquette bonding material, which is concrete that contains Portland cement and silica sand, is melted with the metallic charge. Melting the concrete material consumes a large amount of energy. With the present process, which adds high purity silicon carbide to the metal after melting, the wasted melting energy for the silicon containing product in the cupola is eliminated. In actuality, there is an energy gain with the high purity silicon carbide material rather than a loss since the addition process for the high purity silicon carbide is mildly exothermic. Eliminating the non metallic material is a significant benefit that transmits into large coke savings and higher melting temperatures.

High purity silicon carbide added through cupola tuyeres provides a quick and easily controllable molten metal chemistry adjustment tool. Reaction time between the actual silicon carbide addition and chemical detection in the molten metal exiting the cupola is one to two minutes. This almost instantaneous chemistry correction provides a very fast chemistry correction tool for cupola melters. The new addition process also provides a method for controlling the normal molten metal chemistry variation or “swings” experienced in cupola melting. If desired, increasing molten metal chemistry test frequency permits more frequent chemistry “corrections” and this yields tighter chemistry control. Fine tuning of the molten metal chemistry is now possible. The standard practice of adjusting ratios of charge materials to attain the desired chemistry analysis will be obsolete.

Another advantage high purity silicon carbide provides is that high purity material added to molten metal replaces a greater than expected amount of the lower purity briquette material added via the cupola charge. For example, the table below shows production results which show the replacement of charge silicon carbide by the present process produces a three or four to one favorable ratio factor. Simply stated one pound of the present silicon carbide can replace up to four pounds of the silicon carbide in the brick form. This initial data is based on twelve separately run production tests in a large gray iron cupola.

Production data for Silicon Carbide Tuyere Addition

| | SiC | | SiC |
|---|---|---|---|
| | bricks removed from | Coke removed from | (97%) grain added |
| | cupola charge | cupola charge | cupola tuyeres |
| | 480 | 0 | 120 |
| | 560 | 280 | 90 |
| | 1200 | 600 | 120 |
| | 760 | 570 | 150 |
| | 600 | 450 | 180 |
| | 920 | 690 | 330 |
| | 600 | 450 | 150 |
| | 920 | 690 | 150 |
| | 560 | 280 | 90 |
| | 1200 | 600 | 240 |
| | 760 | 570 | 150 |
| | 920 | 460 | 180 |
| Total | 9480 | 5640 | 1950 |

Thus, 9,480 lb of 60% SiC bricks replaced by 1,950 97% SiC. 5,688 lb. SiC replaced by 1,950 SiC. Replace ratio average−1 lb. granular silicon carbide=2.91 lb. SiC in bricks.

The reduction in silicon content charged into the cupola can also reduce overall silicon oxidation losses. Silicon oxidation losses can reach 40% in normal cupola practice. Although the oxidation rate due to upper melt zone gaseous reactions is not reduced with new process, the overall loss is reduced because of the lower amount of silicon charged. It is also reported that lower charge silicon will provide a reduced overall silicon oxidation loss rate just due to the lower silicon level in the metal. The reduced loss rates tend to stabilize the chemistry levels achieved in the melted metal and result in considerable savings.

Silicon losses associated with slag layer reactions can also be reduced. Reductions in the amount slag generated during the melting process result from the reduction and/or elimination of the concrete briquette material reduce silicon losses. Reductions in briquettes lead to reductions in limestone required which lead to reductions in silicon losses. Production experiences vary but one cupola operation reduced silicon loss from 35% to 18% through the elimination of one half of the briquetted silicon carbide combined with a 30% reduction in limestone. This reduction in silicon loss associated with slag volume/slag composition was demonstrated numerous times when “booster” additions of limestone dramatically reinstated the larger silicon loss and the loss continued for the period of time that it took to return the slag chemistry to the previous composition.

Reductions in coke lead to improved melt rates and/or reductions in combustion gas volume. Excess coke which is used to obtain the required carbon level can lead to higher amounts of carbon monoxide versus carbon dioxide in cupola exhaust gases. Carbon burned to form carbon dioxide liberates 14,500 btu/lb. of carbon as compared to 4,400 btu/lb. for carbon monoxide. With the present system, higher levels of carbon dioxide are allowed without incurring the significant losses that occur with standard cupola practice. Greater energy efficiency is achieved. Melt rate improvements of thirty percent have been achieved through coke reductions made possible by the present process. Cupola operations are provided the option of reducing combustion gases while maintaining the standard melt rate or maintaining the previous combustion gas volume and obtaining the added melt productivity.

In the past, cupolas were designed for a specific carbon pickup capability. This was accomplished primarily by controlling the distance between the tuyeres and the cupola bottom. The greater the distance the more carbon pickup possible. However, the greater the distance the larger the temperature loss. The hottest metal is at tuyere level. Years ago malleable iron cupolas were designed to provide the least carbon pickup possible. All of these cupolas had very shallow wells with several designs trying to eliminate the well. Melting temperatures were very high. With the present system, carbon is externally controlled thereby creating the ability to modify the cupola via raising the cupola bottom. Production experiences with one cupola indicates that raising the cupola bottom six inches lead to a melting temperature increase of approximately thirty to forty degrees. Many studies have been made in the past regarding the relationship between tuyere height and melt temperature but the carbon pickup constraint has always been the controlling factor. The present process removes that constraint.

Installation of the present process is relatively easy. A self contained pneumatic conveyer can be provided to automatically transport the silicon carbide material from a remote foundry floor location into the cupola tuyere. The amount of material per batch transported into the tuyere is regulated and preset at the transporter. The frequency batches are sent to cupola tuyere is determined by melting personnel. The transport cycle needs to be manually initiated, however once initiated the cycle proceeds automatically. Silicon carbide material is contained in supersacks which directly unload into the transporter. The supersack is contained within the transporter unit assembly making the equipment very easy to utilize. The entire process is user friendly and can be fully automated.

### CONCLUSION

The present system provides a practical, efficient method of producing cast iron by which a significant increase in the silicon and carbon content can be achieved in the iron during or after melting. Hence, as suggested by the preceding, large savings can be made in material and fuel costs. One example includes providing an initial cupola charge having a silicon content significantly less than the silicon content required in the melt, loading and melting the charge in a cupola, conducting the molten metal to a mixing vessel, increasing the silicon and carbon content by a substantially continuous addition of granular silicon carbide having a purity of greater than 94% and a size of less than ⅜″ to the mixing vessel while simultaneously agitating the molten metal to an extent sufficient to bring the silicon and carbon into solution with the molten metal, and conducting the silicon-and-carbon-enriched molten metal away from the mixing vessel.

The discussion herein also can apply to a ductile base iron process in addition to the cast iron process discussed above.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A system comprising:
a cupola having one or more tuyeres; and
a granular silicon carbide delivery system communication with at least one tuyere to deliver granular silicon carbide into the cupola through the tuyere.

2. The system of claim 1, wherein the delivery system is a pneumatic system.

3. The system of claim 1, wherein the granular silicon carbide has a purity of greater than 97% and a size of less than ⅜″.

4. The system of claim 1, wherein the granular silicon carbide is added to the cupula a melt zone of the cupola, wherein the melt zone of the cupola is at the level of where the tuyere enters the cupola.
